(19) United States
(12) Patent Application Publication
(10) Pub. No.: US 2018/0273173 A1
(43) Pub. Date: Sep. 27, 2018

(54) AUTONOMOUS INSPECTION OF ELONGATED STRUCTURES USING UNMANNED AERIAL VEHICLES

(71) Applicant: PRO-DRONE LDA, Porto Salvo (PT)

(72) Inventor: André MOURA, Estoril (PT)

(73) Assignee: PRO-DRONE LDA, Porto Salvo (PT)

(21) Appl. No.: 15/762,058

(22) PCT Filed: Sep. 22, 2016
(86) PCT No.: PCT/EP2016/072533

§ 371 Date: Mar. 21, 2018

(30) Foreign Application Priority Data
Sep. 22, 2015 (EP) EP15186251

(51) Int. Cl. B64C 39/02; G05D 1/00; G01N 21/95; G01N 25/72; G01N 29/22

(52) U.S. Cl. CPC B64C 39/024; G05D 1/0094; G05D 1/0088; G01N 21/9515; G01N 25/72; G01N 29/225; B64C 2201/146; G05D 1/0011; B64C 2201/024; B64C 2201/123; B64C 2201/127; B64C 2201/141; G05D 1/0055

(57) ABSTRACT

Devices and methods of autonomously inspecting elongated structures, such as blades of wind turbines, are disclosed. An unmanned aerial vehicle (UAV) is guided towards the elongated structure. The UAV automatically senses distance from the elongated structure. The UAV autonomously maintains a distance greater than a safety distance and identifies an optimum inspecting distance from the elongated structure. The UAV is then autonomously placed at the optimum inspecting distance to automatically record data pertinent to at least a region of the elongated structure when the UAV is at the optimum inspecting distance.

The present disclosure relates to inspection of elongated structures and more specifically to devices and methods for autonomous inspection of elongated structures using unmanned aerial vehicles.

### BACKGROUND ART

Inspecting structures frequently requires the displacement of service personnel with specialized equipment to look for damage or potential defects that may impact its efficiency and/or integrity. In case of elongated structures, such as high towers, bridges, wind turbines etc., precise inspections may require a technician to climb along the structure or to use an unmanned aerial vehicle (UAV) to inspect the structure.

However, climbing along a structure implies a safety hazard and requires particular climbing skills. On the other hand, using an UAV to inspect the structure requires very precise UAV piloting skills. If the structure is large enough, in order to get precise data, e.g. a precise image of the elongated structure or set of images, the pilot may need to have particular UAV piloting skills so that the UAV is positioned with precision with respect to the elongated structure to acquire the relevant images as well as to avoid accidents and collisions.

It is desirable to improve the inspection of elongated structures in an easy, robust and safe way that would provide precise and repeatable data of the elongated structures.

### SUMMARY OF THE INVENTION

In a first aspect a method of remotely inspecting an elongated structure is disclosed. The method comprises guiding an unmanned aerial vehicle (UAV) towards the elongated structure; automatically sensing a distance from the elongated structure, and any other potential structure detected around the UAV; autonomously maintaining the UAV at a distance greater than a safety distance from any detected structure; identifying an optimum inspecting distance from the elongated structure, the optimum inspecting distance being greater than the safety distance; autonomously placing the UAV at the optimum inspecting distance; and automatically recording data pertinent to at least a region of the elongated structure when the UAV is at the optimum inspecting distance.

Guiding the UAV towards the elongated structure may comprise manually piloting the UAV (e.g. with a radio control unit) or inserting or sending flying parameters—(e.g. spatial coordinates) to the UAV so that it may autonomously fly upwards and towards the elongated structure.

By autonomously maintaining the UAV at a distance greater than the safety distance, it is possible for a low-skilled person to manually pilot the UAV towards the elongated structure. The UAV may sense when the UAV approaches the safety distance and an on-board computer may override any control signals received from the pilot to avoid any collision. Furthermore, by autonomously placing the UAV at the optimum inspecting distance, it is possible to acquire accurate and repeatable recordings of the elongated structure. For example, the optimum inspecting distance may be a distance where a dimension of the elongated structure may fit entirely in an image acquired by the UAV. The optimum inspecting distance may be pre-calculated and the on-board computer may be preprogrammed to carry out the maneuvers required to reach, and if required maintain, the optimum inspecting distance. The optimum inspecting distance may be calculated based on characteristics of the recording equipment (e.g. width of the image that the camera may acquire) and characteristics of the elongated structure (width of a dimension, size and shape of the elongated structure). The optimum inspecting distance may also be calculated in flight with data from on-board sensors. It is therefore possible to safely acquire accurate data of the elongated structure without requiring a high-skilled person to pilot the UAV towards the elongated structure. At the same time this automates the process making it more robust and repeatable. Based on the position of the UAV, the on-board computer may either generate flight control signals to force the UAV to approach the elongated structure, if the UAV is beyond the optimum inspecting distance when the elongated structure is detected or, if the UAV is flying between the optimum inspecting distance and the safety distance, the on-board computer may generate flight control signals to force the UAV to increase its distance from the elongated structure in order to reach an optimum data gathering position.

In some examples, automatically sensing a distance from the elongated structure may comprise detecting the elongated structure, continuously measuring the distance from the detected elongated structure, continuously comparing the measured distance with a stored, e.g. in a memory of the on-board computer, parameter value, said stored value corresponding to the safety distance. The UAV may be autonomously guided, i.e. perform autonomous flight maneuvers, when the measured distance is close to the safety distance. To detect the elongated structure the UAV may continuously measure the distance from any structure. Once a structure is sensed, the UAV may apply algorithms, e.g. pattern detection algorithms, to identify if the sensed structured is the desired elongated structure. Once the desired elongated structure is identified, then the UAV may continue measuring the distance and may start comparing the measured distance with the safety distance.

In some examples, automatically maintaining the UAV at a distance greater than the safety distance may comprise measuring the distance from the elongated structure, identifying a flight direction and velocity of the UAV, identifying a piloting maneuver as a hazardous maneuver as a factor of said distance measuring, said direction identification and said velocity, and autonomously overriding the hazardous maneuver. In order to perform the overriding function smoothly, the on-board computer may gradually apply a braking control signal to the flight management unit based on the measured direction and velocity. The aim would be to reach a zero velocity at the safety distance, assuming this is at least partially the direction of travel. Therefore, the on-board computer may override the remote control signals by limiting the velocity or by changing the flight direction.

In some examples, autonomously placing the UAV at the optimum inspecting distance may comprise measuring the distance from the elongated structure and then increasing the distance from the elongated structure if the measured distance is lower than the optimum inspecting distance or decreasing the distance otherwise. The on-board computer may maintain the UAV at the optimum inspecting distance once the measured distance is equal to the optimum inspecting distance. This may allow a clear shot of the elongated structure.

In some examples, identifying an optimum inspecting distance from the elongated structure may comprise identifying a distance where a preselected area of the elongated structure may be recordable. The preselected area may be an area including a section of the elongated structure where at least two edges may be visible. For example, if the elongated structure is a vertical tower, the preselected area may include a section of the tower where at least two edges of the tower, i.e. two borders, one to the left of the image and one to the right of the image may be visible. A boundary or tolerance area may also be recordable to make sure that the preselected section may always entirely fit in the image. In case the elongated structure has a different width along its length, then the preselected section may refer to the section having the larger width. Alternatively, the optimal distance may be autonomously adjusted based on the measured width of the vertical structure. In that way, a complete section of the structure may always remain in view and the best possible proximity may be achieved without entering the safety zone.

In some examples, automatically recording at least a region of the elongated structure when the UAV is at the optimum inspecting distance may comprise autonomously flying the UAV along a path parallel to the longitudinal axis of the elongated structure, identifying the region and acquiring data of the elongated structure pertinent to the identified region. The region may be a region adjacent to the predefined area or section. Otherwise it may be a limit region, that is, an extremity of the elongated structure. By flying the UAV along a path parallel to the elongated structure it may be possible to record data from a larger region, section or even the complete elongated structure, e.g. in consecutive images or in a video recording.

In some examples the method may further comprise identifying a central axis of a region of the elongated structure, autonomously centering the UAV with respect to the identified central axis and autonomously flying the UAV along a path parallel to the elongated structure. The UAV may then be maintained centered with respect to the identified central axis. By centering the UAV with respect to the identified central axis of the elongated structure it may autonomously adjust itself to the center without the help of the pilot.

In some examples, the method may further comprise identifying the central axis and edges of the elongated structure, and autonomously flying the UAV along a predefined flight path, which allows the UAV to acquire footage from the center and both edges of the elongated structure, for example a “Z” pattern using both edges as endpoints of the pattern.

In some examples, the UAV may be placed facing a first side of the elongated structure. It may then automatically fly along a predetermined flight path on the first side of the elongated structure in a direction to record the first side. After recording the first side it may automatically fly around the structure, e.g. ninety degrees if the structure has four sides, along a rotational path direction to be placed facing a second side of the elongated structure. It may then fly along a predetermined flight path on the second side of the elongated structure in a direction to record the second side.

If desired, after recording the second side it may automatically fly another approximately ninety degrees along a similar rotational path direction around the structure, e.g. in the case of a four sided structure, to be placed facing a third side of the elongated structure. It may then fly along a predetermined flight path on the third side of the elongated structure in a direction to record the third side. This flight pattern may be advantageous for recording substantially cylindrical or flat elongated structures, such as wind turbine blades. It may minimize the flight time which may minimize energy consumption of the UAV.

In some examples, autonomously centering may comprise identifying a first distance from a first border of the elongated structure, identifying a second distance from a second border of the elongated structure, displacing the UAV until the first distance is equal to the second distance. The two borders may have been identified when the elongated object was detected. The UAV may measure the distance from the first border and from the second border. If the two distances coincide then the UAV may be considered centered with respect to the elongated object. Otherwise, one distance may be greater than the other. It may then be assumed that the UAV needs to be displaced laterally towards the border that appears to be more distant until the two distances are measured to be substantially equal. The lateral movement may be effected autonomously and the UAV may be programmed to perform said lateral movement once the two distances are found to be unequal.

In some examples, autonomously centering may comprise identifying the border positions or border point positions of the elongated structure, converting them to coordinates in space related to the UAV. For example, The UAV may calculate the middle position between the border positions and laterally displace itself to be in the desired centered coordinates. It may be assumed that the UAV will autonomously correct displacements from that centered position.

In some examples, autonomously centering may comprise identifying a first border point of the elongated structure, identifying a second border point of the elongated structure, measuring the angles of both identified border points related to the orientation of the UAV and rotationally displacing the UAV until the first angle is symmetrical to the second angle. For example, an on-board sensor may measure the the first angle and the second angle of the elongated structure related to the center of the UAV. If the two angles coincide, then the UAV may be considered perpendicular with respect to the elongated object. Otherwise, one angle may be greater than the other. It may then be assumed that the UAV needs to rotate towards the border that appears to be more off centered, i.e. the border that is measured to have the largest angle, until the two angles are measured to be substantially equal. The rotation movement may be effected autonomously and the UAV may be programmed to perform said rotational movement once the two angles are found to be unequal.

In some examples, the UAV may detect a structure above it, besides the elongated structures around it. It may then measure the vertical distance to the above detected structure so that that distance is never below a set safety distance. It may then apply a command so that the measured distance is never below a predetermined safety distance, or apply a braking command so that the velocity in the direction of the structure is zero when the measured distance is equal to the set safety distance.

In some examples, the elongated structure may be an element of a wind turbine. For example the elongated structure may be a blade of a wind turbine. The wind turbine may comprise a tower and a nacelle and the blade may be attached at one point of the nacelle. In some examples, the elongated structure may be a vertical structure. In the case of a blade of a wind turbine, the blade may be vertically aligned with the tower of the wind turbine. The UAV may then identify the blade as the elongated structure to be inspected and maintain a safety distance from both the blade and from the tower.

In another aspect, a UAV is disclosed. The UAV may comprise (i) a frame, (ii) a propulsion unit to direct the UAV, (iii) one or more remote sensing devices to continuously sense the distance of the UAV from elongated structures, (iv) one or more data acquisition modules to record data of elongated structures, (v) a communication module to receive flight instructions and send flight parameters and recorded data to a remote control center, (vi) a processing module, coupled to the one or more remote sensing devices, the one or more data acquisition modules and the communication module to receive instructions from the one or more remote sensing devices and from the communication module to set flight parameters and to actuate on the one or more data acquisition modules, and (vii) a flight management unit (FMU), coupled to the processing module and to the propulsion unit, to receive flight parameters, generate control signals and direct the control signals to the propulsion unit. The FMU may be configured to set flight parameters based on instructions received from the communication module when the one or more remote sensing devices identify a flight path as a safe path. The FMU may also be configured to set flight parameters based on instructions received from the processing module when the one or more remote sensing devices identify a flight path as a hazardous path. Furthermore, the FMU may be configured to set flight parameters based on instructions received from the processing module when the one or more remote sensing devices identify an optimum inspecting distance. The FMU may also be configured to receive instructions from the communication module to set flight parameters based on instructions received from the processing module. For example, a pilot may instruct the FMU to fly autonomously and follow a preprogrammed flight path stored with the processing module.

In some examples, the one or more remote sensing devices may comprise a LIDAR.

In some examples, the one or more remote sensing devices may comprise a sonar.

In some examples, the one or more remote sensing devices may comprise a laser range finder, with a video camera and image processing for positioning information.

In some examples, the one or more remote sensing devices may comprise a stereoscopic camera and distance and positioning information may come from the stereoscopic camera with image processing, where the images captured by the stereoscopic camera are processed to identify distances and positions.

In some examples, the distance and positioning information may come from two separate cameras positioned at some distance, giving stereo footage for image processing.

In some examples, the one or more data acquisition modules may comprise one or more of a high definition camera, a thermal camera and an ultrasound sensor.

In some examples, the method may comprise using one or more UAVs, each using an array of sensors to collect data about the elongated structure and its environment, using said data from said array of sensors to build a three-dimensional (3D) model of the environment in which the elongated structure is included, using said 3D model to build an optimal flight path, autonomously navigating according to said flight path, while acquiring data relevant for the inspection of the elongated structure. An initial pattern of the elongated structure to be inspected may be stored in a memory of the on-board computer so that the elongated structure may be identified on the 3D model. This 3D model may be continuously updated with the data obtained from said array of sensors.

In some examples data relevant for the inspection of the elongated structure may be acquired using said array of sensors.

In some examples the general disposition of the elongated structure may be predetermined and used as an initial 3D model. The 3D model may then be continuously updated with data collected by said array of sensors about the elongated structure and its environment. This may allow the UAV to be autonomously guided to other parts of the elongated structure to be inspected, or may allow optimization of the flight path.

In some examples the array of sensors may comprise one or more of a multispectral camera, a laser scanner, a stereoscopic camera, a sonar, a GPS or any other sensor capable of acquiring data about the elongated structure and its environment.

In some examples, the UAV may comprise an articulated structure, e.g. a gimbal, and the array of sensors may be mounted on the articulated structure, with orientation control and sensors. This may allow optimal orientation of the sensors relative to the elongated structure.

In some examples, when two or more UAVs are being used simultaneously they may share the data provided by their respective array of sensors and their computational resources. This may enable a creation of a common 3D model of the elongated structure and its environment. Said common 3D model may be used to optimize the flight paths of the individual UAV. In some examples, the common 3D model may be stored in a distributed fashion, where each individual UAV may store at least part of said common 3D model, so that the whole common 3D model may be stored in the collective memory of the UAVs. Said part of the 3D model may be used by the UAVs to collaboratively plan the individual flight paths so that the whole elongated structure is covered, collisions between UAVs may be avoided and the inspection time may be optimized.

In some examples, said common 3D model may be stored in a central computer which may share at least a part of said common 3D model with the UAV which may use it to collaboratively plan optimal individual flight paths. In some examples, said central computer may plan flight paths for the individual UAVs based on the whole 3D model and the current location of the individual UAVs within said common 3D model, in order to optimize the inspection time.

In another aspect, a computer program product is disclosed. The computer program product may include machine readable instructions that when executed by a computing system may provoke the computing system to perform a method of remotely inspecting an elongated structure.

Additional objects, advantages and features of embodiments of the invention will become apparent to those skilled in the art upon examination of the description, or may be learned by practice of the invention.

### BRIEF DESCRIPTION OF THE DRAWINGS

Particular embodiments of the present invention will be described in the following by way of non-limiting examples, with reference to the appended drawings, in which:

FIG. 1 schematically illustrates a wind turbine blade inspecting mission;

FIG. 2 illustrates a recording mission at the optimum inspecting distance;

FIG. 3 is a block diagram of a UAV for inspecting elongated structures;

FIG. 4 is a flow diagram of a method of inspecting an elongated structure.

### DETAILED DESCRIPTION OF EMBODIMENTS

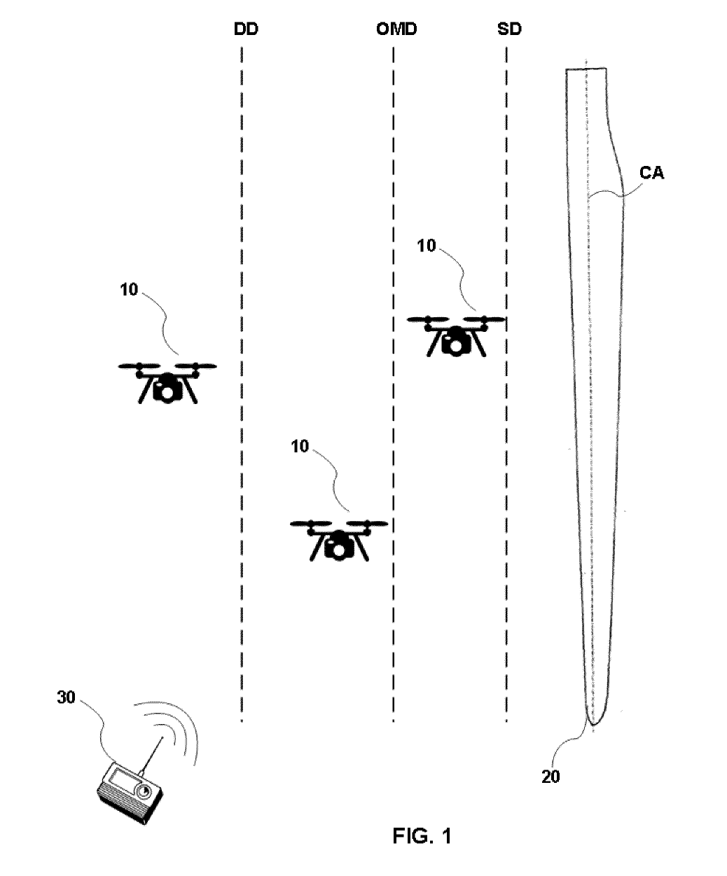

FIG. 1 schematically illustrates a wind turbine blade inspecting mission. During a first stage of the mission, a user may pilot the UAV 10 towards the blade 20 using a remote controller 30. Alternatively, the user may provide coordinates to the UAV so as to autonomously fly to the mission area. The UAV may comprise one or more remote sensing devices, e.g. a LIDAR, or an array of sensors, that may be used to measure the distance of the UAV from any structures that may be in the path of the UAV. During flight the UAV 10 may use data from the sensors to build and update a 3D model of the environment in which the wind turbine and the wind turbine blade are included and use said 3D model to build an optimal flight path. It may then autonomously navigate according to said flight path, while acquiring data relevant for the inspection of the wind turbine blade. Assuming that there are no other detectable structures in the way, the UAV may reach a first limit, the detection limit that may be at a distance where the UAV may sense the presence of the blade. This limit is represented in the drawing by the line DD that corresponds to the detection distance. When the UAV reaches this limit, it may sense a structure and may recognise that the detected structure is the target of the mission, i.e. the blade to be inspected. When the UAV recognises the target, an on-board computer may override the remotely controlled piloting of the UAV and assume control of the flight. Alternatively, the pilot may operate a switch to allow the UAV to assume control of the flight. The on-board computer may then direct the UAV to a second limit, at an optimum inspecting distance (OID), where a data acquisition device on-board the UAV may optimally perform recording of features of the blade. For example, the data acquisition device may be a high definition camera that may capture images of regions of the blade. The OID may be a pre-calculated distance where any images captured may include a region extending across the entire width of the blade. The UAV may be programmed to hover, i.e. fly suspended in the air, at a certain height along the OID so that a clear image may be captured. The OID may be adjusted automatically to the width of the elongated structure, by using the distance and width measurement, moving closer where it has a shorter width and further away where it has a larger width. During the time that the UAV is hovering, the pilot may be allowed to assume partial control of the UAV and approach the blade to get a closer look at a region of interest (ROI) that may include a specific feature, for example, to get a closer look at a potential defect. As the pilot maneuvers the UAV towards the blade, the remote sensing device may measure the distance, direction and speed of the UAV to make sure that a third limit, a safety distance (SD) from the blade, is not violated. The on-board computer, based on information from the remote sensing device, may, therefore, apply a braking command so that the speed of the UAV when it reaches the SD is equal to zero. The pilot may then select to capture an extra close-up image of the ROI. When the close-up mission has finished, the pilot may direct the UAV backwards, towards the OID or may simply hand over control to the on-board computer. The on-board computer may then return the UAV at the OID.

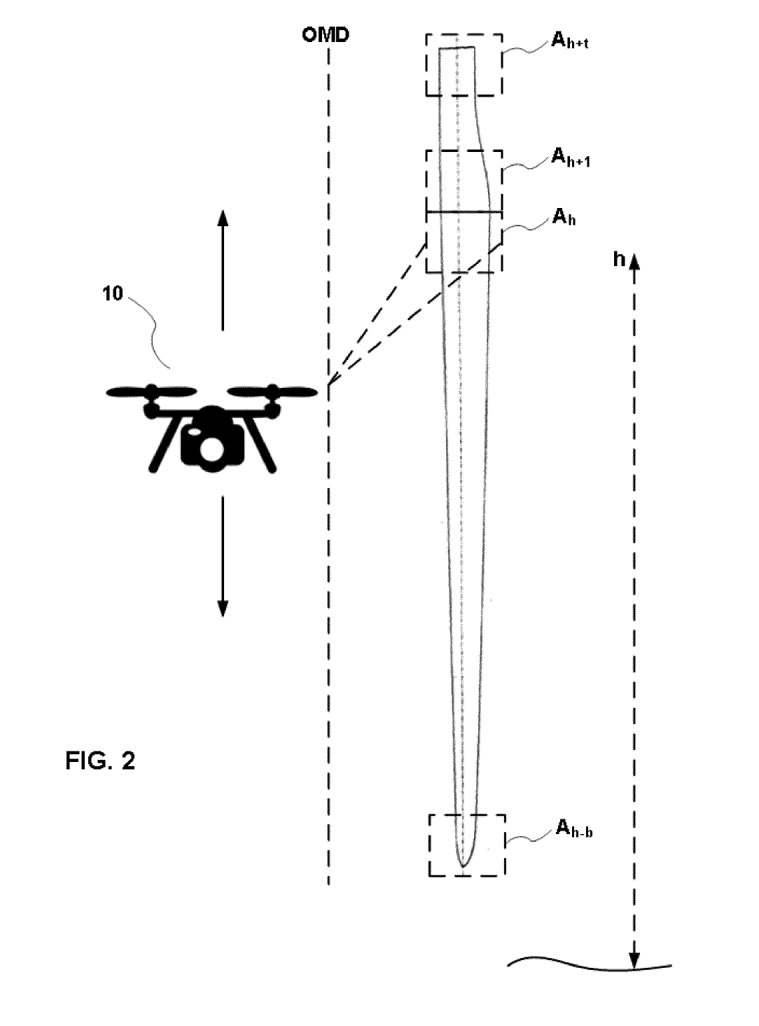

FIG. 2 illustrates a recording mission at the optimum inspecting distance. When the on-board computer has directed the UAV to the OID, then a series of image recordings may take place. In one example implementation, the on-board computer may direct the UAV towards a first height h at a point along the path of the OID parallel to a vertical object (e.g. blade). The UAV would then decrease its altitude until it has detected the bottom extremity of the blade. Then a first image may be acquired including a first region A_{h-b} of the elongated structure. Then the on-board computer may direct the UAV upwards at a second height, different from the first height, higher with respect to the first height. The second height may be selected so that a second image may be captured that would include a second region Aₕ₊₁ of the elongated object that would be adjacent to the region that was included in the first image. The first part of the recording mission may continue until the UAV reaches the top extremity of the vertical structure being inspected. Following the detection of the top extremity, the on-board computer may direct the UAV so that the mission may continue. The UAV may hover at various points along the vertical object in order to acquire a set of images.

As mentioned before, at any height the pilot may intervene and direct the UAV closer to the vertical object in order to acquire a close-up image of the respective region. Alternatively or additionally, a zoom function may be employed at the camera to acquire a close-up image of the region. It may, therefore, be considered that, once the on-board computer has assumed control of the UAV, the pilot may only have control over only some degrees of freedom of the UAV, e.g. the vertical direction or the horizontal direction, towards the blade. And this direction towards the blade may be limited by the safety distance. In other implementations the pilot may also have control over lateral movements of the UAV, to allow close-up images to be taken across a section of a region of the elongated object.

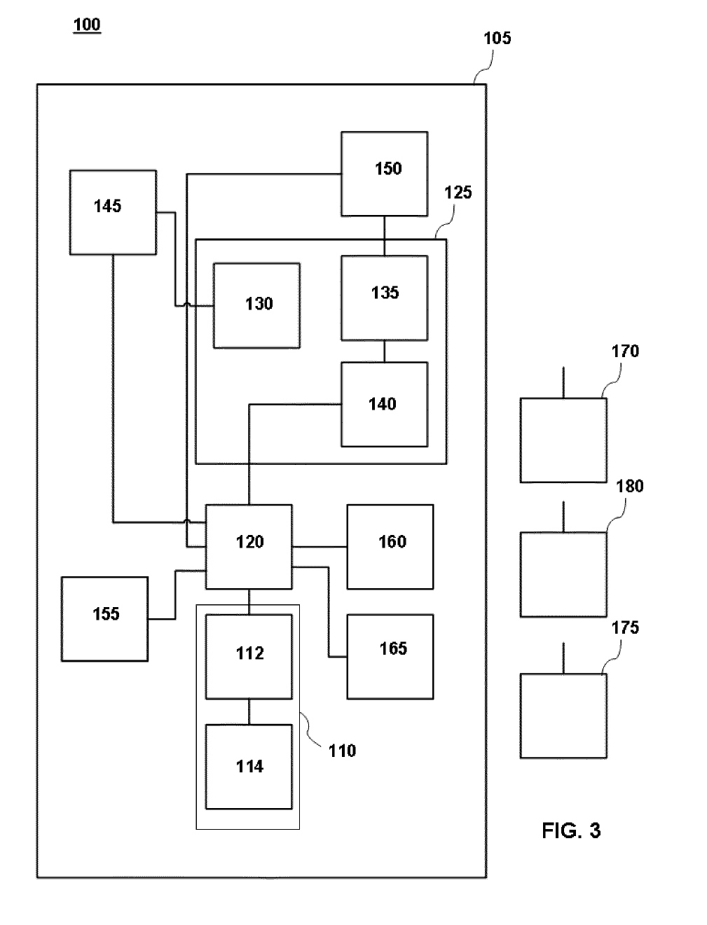

FIG. 3 is a block diagram of a UAV for inspecting elongated structures. The UAV 100 may comprise a frame 105 and a propulsion system 110 attached to the frame 105. The propulsion system 110 may be controlled by a flight management unit (FMU) 120. The propulsion system may comprise speed controllers 112 coupled to motors 114. The FMU 120 may instruct the speed for the speed controllers 112 which in turn may control the speed of the motors 114 and thereby the speed of the UAV. The UAV 100 may further comprise a gimbal 125 where a remote sensing device 130, such as a LIDAR, a data acquisition module 135 and a remote controller 140 for the data acquisition module 135 may be mounted on. The data acquisition module 135 may comprise an industrial camera, e.g. a high definition camera, to deliver millimetric precision of the elongated structure. The data acquisition module may additionally or alternatively comprise a thermal camera to perform thermal inspections, either induced or passive. The remote sensing device 130, e.g. LIDAR, may measure distance by illuminating a target with a laser and analyzing the reflected light and may measure ranges and angles of objects in front of the UAV. It may be coupled to an on-board computer 145 that may calculate the position of the UAV in relation to the structures in front of the UAV. The on-board computer 145 may be coupled to the FMU 120 to provide position control commands (or maneuver instructions) to the FMU 120. The on-board computer 145 may receive data from the remote sensing device 130 and the remote controller 170 and select between a manual (pilot) flying mode and autonomous or semi-autonomous flying modes. There may be several autonomous modes that the pilot may switch between. For example, one autonomous mode may require a centered UAV to go up or down or remain stationary with respect to a vertical structure. Another autonomous mode may require a UAV to remain stationary or get closer to the elongated structure. Yet another mode may require the UAV to remain stationary or to get further, i.e. distance itself from the elongated structure. In case a complete scanning of the elongated structure is required, e.g. in case a vertical blade of a wind turbine is recorded, the autonomous mode may require flying autonomously along a first vertical direction to record a first side, e.g. the upper surface of the blade, hovering ninety degrees to a second side, e.g. to face an edge of the blade, flying autonomously vertically along a second direction, opposite to the first, to record the side, e.g. the leading edge or the trailing edge, and then hovering another ninety degrees to record a third side, e.g. the lower surface of the blade. The UAV may then fly autonomously vertically along the first direction to record the third side. If required, the UAV may perform another rotational flying movement to place itself against the fourth side, e.g. the other edge of the blade, so that a complete photographic “sweeping”, i.e. recording of the entire surface of the elongated structure may be performed.

The data acquisition module 135 may be coupled to the remote controller 140 and may receive control commands from the remote controller. The remote controller 140 may receive camera control parameters relayed from the FMU 120, via e.g. a USB port, that may be sent from a remote camera control unit 180. The remote camera control unit 180 may transmit position, shooting and zooming instructions to the data acquisition module 135. The data acquisition module 135 may be a High Definition (HD) photo/video camera and may store any pictures/video in an internal memory such as an SD card. The UAV 100 may further comprise a video link module 150 to transmit video to the user on the ground. The video link module 150 may transmit HD video to the ground so that the inspector may visualise in real time the elongated structure. A telemetry transceiver 155 may be coupled to the FMU 120 and may transmit flight parameters to a ground station controller 175. The FMU 120 may also be coupled to a receiver 160 that may receive flight control parameters from a radio control unit 170 as well as camera control parameters from the remote camera control unit 180. Finally the UAV may comprise a GPS module 165, coupled to the FMU 120 to provide positioning information to the FMU 120.

In one flying scenario, when the UAV is approaching the elongated structure, if no signal is received from the remote sensing device 130, this may be an indication that no structure has been sensed and therefore the pilot may continue flying the UAV in manual mode. When the remote sensing device 130 senses a structure, it may measure a distance from the sensed structure and send this measurement to the on-board computer 145. The on-board computer 145 may compare the measured distance with pre-stored distances to determine if the UAV is within an inspecting zone. For example, a inspecting zone may be defined as a zone where the UAV may recognize an elongated structure and perform inspecting operations. If the UAV is beyond the inspecting zone, the on-board computer 145 may allow the pilot to perform manual maneuvers to approach the elongated structure and enter the inspecting zone. Once the remote sensing device 130 measures a distance within the inspecting zone, the on-board computer 145 may select to partially or completely override the manual flight mode and take control of the FMU 120. The decision may be based on the speed, direction and distance of the UAV from the elongated structure. The on-board computer 145 may then assume control and disregard any potentially hazardous control instructions received at the receiver 160 from the remote controller 170. A hazardous control instruction may be e.g. an instruction to approach the elongated structure beyond the safety distance. The on-board computer 145 may comprise a memory having pre-stored values of a safety distance and of an optimum inspecting distance or optimum inspecting distance path as a factor of measured width of the elongated structure. Then the on-board computer 145, in function of the distance received from the remote sensing device 130 and the pre-stored values of the safety distance and optimum inspecting distance, may generate control signals to the FMU 120 to displace the UAV towards the optimum inspecting distance. Once the UAV arrives at the optimum inspecting distance, then the on-board computer 145 may receive instructions, i.e. flying parameters, arriving at the receiver 160 to allow the UAV to approach further the elongated structure while making sure that the safety distance is maintained.

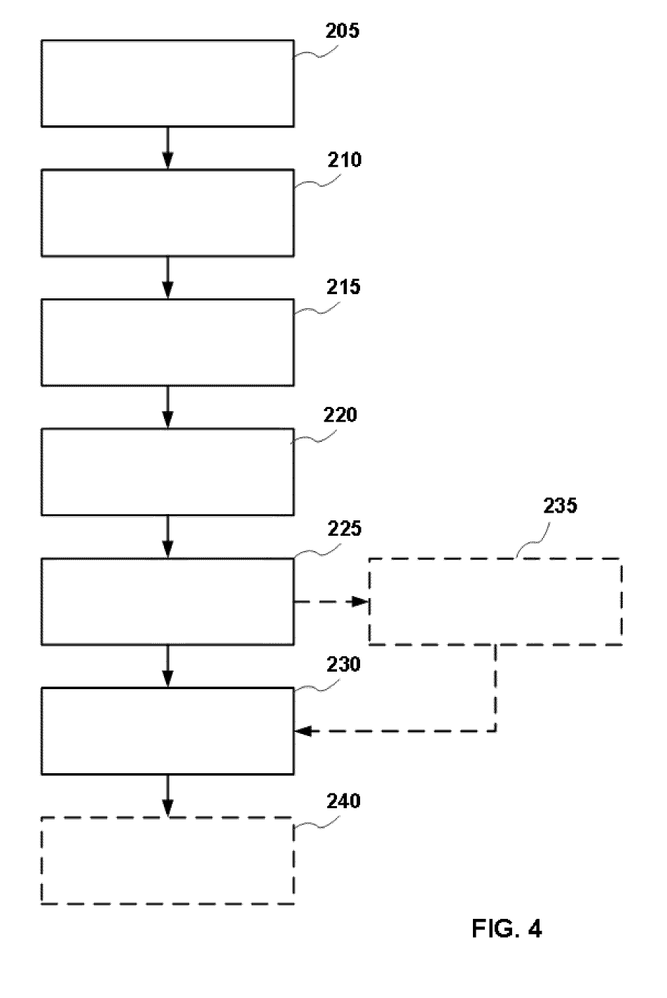

FIG. 4 is a flow diagram of a method of inspecting an elongated structure. In a first block 205, an unmanned aerial vehicle may be manually piloted towards the elongated structure. Then, in block 210, a safety distance from the elongated structure may be identified. The safety distance may be predetermined, i.e. the value of the safety distance may be preprogrammed in the controller of the UAV. Alternatively, the UAV may calculate the safety distance based on the size of the elongated structure or based on weather conditions, e.g. wind, and stability considerations. In block 215 the UAV may be autonomously maintained at a distance greater than the safety distance.

The UAV may compare distances from objects and structures and make sure that, at any given point, it remains at least as far away as the safety distance from any obstacle or structure. In block 220, an optimum inspecting distance, being greater than the safety distance, from the elongated structure may be identified. In block 225, the UAV may be autonomously placed at the optimum inspecting distance. Then, in block 230, at least a region of the elongated structure may be automatically recorded in an image or video when the UAV is at the optimum inspecting distance. When the UAV is automatically placed at the optimum inspecting distance, the process may continue in block 235 to centre the UAV with respect to a central axis of the elongated structure. Furthermore, after a region of the elongated structure is automatically recorded in an image or video when the UAV is at the optimum inspecting distance, the process may continue in block 240 where the UAV may be autonomously flown along a path parallel to the elongated structure to capture data, such as a plurality of images or a video sequence or other data pertinent to larger sections of or to the entire elongated structure.

In the various examples proposed herein, systems have been described in terms of modules and connections between them for the sake of clarity. In alternative examples, some of the described modules may be integrated in a single module. These modules and connections may be implemented physically. Nevertheless, in alternative implementations, the functionalities performed by said modules and connections may also be implemented logically by e.g. suitably programming a programmable control unit, such as e.g. a PLC (Programmable Logic Controller). A module may be defined as a piece of hardware and/or software implementing one or more functionalities.

All or some of the proposed modules may comprise electronic/computing means. These electronic/computing means may be used interchangeably; that is, a part of said means may be electronic means and the other part may be computing means, or all said means may be electronic means or all said means may be computing means.

The electronic means may comprise e.g. a programmable electronic device such as a CPLD (Complex Programmable Logic Device), an FPGA (Field Programmable Gate Array) or an ASIC (Application-Specific Integrated Circuit).

The computing means may comprise a computing device that may comprise a memory and a processor. The memory may be configured to store a series of computer program instructions constituting any of the computer programs proposed herein. The processor may be configured to execute these instructions stored in the memory in order to generate the various events and actions for which the system has been programmed.

The computer program (which may be stored in the memory of the system) may comprise program instructions for causing the system to perform any of the methods described in the context of the previous examples. The computer program may be embodied on a storage medium (for example, a CD-ROM, a DVD, a USB drive, an sd-card, on a computer memory or on a read-only memory) or carried on a carrier signal (for example, on an electrical or optical carrier signal).

The computer program may be in the form of source code, object code, a code intermediate source and object code such as in partially compiled form, or in any other form suitable for use in the implementation of the method. The carrier may be any entity or device capable of carrying the computer program.

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

When the computer program is embodied in a signal that may be conveyed directly by a cable or other device or means, the carrier may be constituted by such cable or other device or means.

Alternatively, the carrier may be an integrated circuit in which the computer program is embedded, the integrated circuit being adapted for performing, or for use in the performance of, the relevant methods.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Thus, the scope of the present invention should not be limited by particular embodiments, but should be determined only by a fair reading of the claims that follow.

1. A method of remotely inspecting an elongated structure using an autonomous mode and a manual mode of operation, comprising:
guiding an unmanned aerial vehicle towards the elongated structure;
automatically sensing a distance from the elongated structure;
identifying an optimum inspecting distance from the elongated structure, the optimum inspecting distance being greater than the safety distance;
autonomously placing the UAV at the optimum inspecting distance,
wherein, during the autonomous mode of operation, the UAV is automatically recording data pertinent to at least a region of the elongated structure when the UAV is at the optimum inspecting distance and wherein, during the manual mode of operation, the UAV is maintained autonomously at a distance greater than a safety distance, the safety distance being smaller than the optimum inspecting distance.

2. The method according to claim 1, wherein automatically sensing comprises:
detecting the elongated structure;
continuously measuring the distance from the detected elongated structure;
continuously comparing the measured distance with a stored value, said stored value corresponding to the safety distance;
wherein the UAV is autonomously guided when the measured distance is close to the safety distance.

3. The method according to claim 1 or 2, wherein autonomously maintaining the UAV at a distance greater than the safety distance comprises:
measuring the distance from the elongated structure;
identifying a flight direction and velocity of the UAV;
identifying a piloting maneuver as a hazardous maneuver as a factor of said distance measuring, said direction identification and said velocity;
autonomously overriding the hazardous maneuver by limiting the velocity or changing the flight direction;

4. The method according to any of the above claims, wherein autonomously placing the UAV at the optimum inspecting distance comprises:
measuring the distance from the elongated structure;
increasing the distance from the elongated structure if the measured distance is lower than the optimum monitoring distance or decreasing the distance otherwise;
maintaining the UAV at the optimum inspecting distance once the measured distance is equal to the optimum inspecting distance,
wherein identifying an optimum inspecting distance from the elongated structure comprises identifying a distance where a preselected area of the elongated structure is recordable.

5. The method according to any of the above claims, wherein automatically recording at least a region of the elongated structure when the UAV is at the optimum inspecting distance comprises:
autonomously flying the UAV along a path parallel to the longitudinal axis of the elongated structure;
identifying the region;
acquiring data of the elongated structure pertinent to the identified region.

6. The method according to any of the above claims further comprising:
identifying a central axis of a region of the elongated structure;
autonomously centering the UAV with respect to the identified central axis;
autonomously flying the UAV along a path parallel to the elongated structure, wherein the UAV is maintained centered with respect to the identified central axis.

7. The method according to claim 6, further comprising:
autonomously flying the UAV in a first direction to record a first side;
autonomously flying the UAV around the elongated structure to face a second side;
autonomously displacing the UAV in a second direction, opposite the first to record a second side.

8. The method according to claim 6 or 7, wherein autonomously centering comprises:
identifying a first distance from a first border of the elongated structure;
identifying a second distance from a second border of the elongated structure;
displacing the UAV until the first distance is equal to the second distance.

9. The method according to claim 6 or 7, wherein autonomously centering comprises:
identifying a first border point of the elongated structure;
identifying a second border point of the elongated structure;
converting both border points to coordinates related to the UAV;
calculating coordinates of a center point;
displacing the UAV until the UAV is at the center point

10. The method according to any of claims 6 to 9, wherein autonomously centering comprises:
identifying a first border point of the elongated structure;
identifying a second border point of the elongated structure;
measuring the angles of both identified border points related to the orientation of the UAV;
rotationally displacing the UAV until the first angle is symmetrical to the second angle.

11. The method according to any of the above claims, wherein the elongated structure is an element of a wind turbine.

12. An unmanned aerial vehicle (UAV) comprising:
a frame;
a propulsion unit to direct the UAV;
one or more remote sensing devices, to continuously sense the distance of the UAV from elongated structures;
one or more data acquisition module, to record data of elongated structures;
a communication module, to receive flight instructions from and send flight parameters and recordings to a remote control center;
a processing module, coupled to the one or more remote sensing devices, the one or more data acquisition modules and the communication module to receive instructions from the one or more remote sensing devices and from the communication module to set flight parameters and to actuate on the one or more data acquisition modules;
a flight management unit, coupled to the processing module, to the propulsion unit and to the communication module, to receive flight parameters, generate control signals and direct the control signals to the propulsion unit;
wherein the flight management unit is configured to:
set flight parameters based on instructions received from the communication module when the one or more remote sensing devices identifies a flight path as a safe path in a manual mode of operation;
set flight parameters based on instructions received from the processing module when the one or more remote sensing devices identifies a flight path as a hazardous path in an autonomous mode of operation;
set flight parameters based on default inspecting instructions received from the processing module when the one or more remote sensing devices identifies a distance from the elongated structure as an optimum inspecting distance, based on a pre-calculated distance value, in an autonomous mode of operation.

13. The UAV according to claim 12, wherein the one or more remote sensing devices comprises one or more of a LIDAR, a laser range finder, a stereoscopic camera with an image processing module, and a sonar.

14. The UAV according to any of claim 12 or 13, wherein the one or more data acquisition modules comprise one or more of a high definition camera, a thermal camera and an ultrasound sensor.

15. A computer program product including machine readable instructions that when executed by a computing system may provoke the computing system to perform a method of remotely inspecting an elongated structure, according to any of claims 1 to 11.
